(19) United States
(12) Patent Application Publication
(10) Pub. No.: US 2009/0083147 A1
(43) Pub. Date: Mar. 26, 2009

(54) Separation of advertising content and control

(76) Inventors: Toni Paila, Stamford, CT (US); Harry Santamaki, New York City, NY (US)

Correspondence Address: Hollingsworth & Funk, LLC, 8009 34th Avenue South, Suite 125, Minneapolis, MN, 54425, US

(21) Appl. No.: 11/903,376

(22) Filed: Sep. 21, 2007

(51) Int. Cl. G06Q 30/00

(52) U.S. Cl. 705/14

(57) ABSTRACT

Customized advertising using independent ad content and ad rules involves acquiring particular advertising content to a particular user terminal. Terminal-resident advertising control rules that are associated with the particular user terminal are defined. The advertising control rules are independent of the particular advertising content. A triggering event associated with a runtime operation of the particular terminal is determined, and the advertising control rules are invoked in response to the triggering event. The particular advertising content is rendered to the user via a terminal user application in accordance with the advertising control rules.

### FIELD OF THE INVENTION

This invention relates to providing personalized advertisements on computing devices.

### BACKGROUND OF THE INVENTION

The ubiquity of cellular phones and similar mobile electronics has led to demands for ever more advanced features in these devices. One feature that is of particular value in such devices is the ability to connect to the Internet and other networks. In near future, many aspects of the global networks such as the World Wide Web will be shifting to cater to mobile device users. The ability of mobile devices to receive data from wherever the user is located will provide additional opportunities to adapt content and increase the value of such content to the end user. Also, increasingly, these devices are capable of receiving digital broadcast transmissions (DVB-H, etc.) and are capable of connecting to variety of networks and network devices through local interface connections (such as USB, Bluetooth)

The always-on and always-connected nature of mobile devices makes them useful in the context of advertising. As with a home computer user, the mobile device user has the capability to order items via an e-commerce Web site in response to an advertisement. However, because these devices are mobile, the users may also be able to take advantage of advertising offers spontaneously while on the go, such as offered by nearby “brick and mortar” businesses. The portability and personal nature of mobile devices means that many new applications will emerge that take advantage of these characteristics. However, users may be wary of allowing any advertisements on their devices if such ads become more of an annoyance than a benefit. Therefore, it may be important to advertisers and end-users to ensure that advertising materials can be made relevant and personalized, and thereby increase the benefits of such advertisements to both users and advertisers.

### SUMMARY OF THE INVENTION

To overcome limitations in the prior art described above, and to overcome other limitations that will become apparent upon reading and understanding the present specification, the present invention discloses a system, apparatus and method for presenting tailored ads in user computing devices. In accordance with one embodiment of the invention, a method involves acquiring, via a network, particular advertising content to a particular user terminal and defining terminal-resident advertising control rules that are associated with the particular user terminal. The advertising control rules are independent of the particular advertising content. The method further involves determining a triggering event associated with a runtime operation of the particular terminal, invoking the advertising control rules in response to the triggering event, and rendering the particular advertising content to the user via a terminal user application in accordance with the advertising control rules.

In a more particular embodiment, the method further involves dynamically generating the advertising control rules based on an attempt to access the rule by the terminal user application. In one case, defining the terminal-resident advertising control rules involves defining the advertising rules via a middleware component having an advertising application program interface accessible via the terminal user application. In such a case, the triggering event may include an access of the advertising application program interface via the terminal user application, and invoking the terminal-resident advertising control rules may involve invoking at least part of the terminal-resident advertising control rules by the middleware component.

Also in such a case, defining the terminal-resident advertising control rules may involve dynamically generating the advertising control rules via the middleware component based on an access of the advertising application program interface via the terminal user application. In these cases, the access of the advertising application program interface may involve providing a client application identifier, a terminal context, and a user identifier from the terminal user application to the middleware component, and the middleware component may dynamically generate the advertising control rules based on the client application identifier, the terminal context, and the user identifier.

In another more particular embodiment of the method, acquiring the particular advertising content to the particular user terminal may involve downloading the particular advertising content independently of the triggering event. In one scenario, the method may further involve defining the triggering event in the terminal-resident advertising rules.

In another embodiment of the invention, a terminal device includes a network interface, memory, and a processor disposed between the memory and the network interface. The memory stores a user application and has instructions that causes the processor to: a) acquire, via the network interface, particular advertising content to the terminal device; b) define terminal-resident advertising control rules that are associated with the terminal device, wherein the advertising control rules are independent of advertising content; c) determine a triggering event associated with a runtime operation of the terminal device; e) invoke the terminal-resident advertising control rules in response to the triggering event; and f) render the particular advertising content to the user application in accordance with the advertising control rules.

In a more particular embodiment, the terminal device further includes a middleware component stored in the memory. The middleware component has an advertising application program interface accessible via the user application, and the middleware component has instructions that at least cause the processor to define the advertising control rules that are associated with the terminal device. In such a configuration, the middleware may also have instructions that cause the processor to determine the triggering event based on an access of the advertising application program interface via the terminal user application, and/or to define the terminal-resident advertising control rules by dynamically generating the advertising control rules based on an access of the advertising application program interface via the user application. In the latter event, the user application may provide provides a client application identifier, a terminal context, and a user identifier from the terminal user application to the middleware component when accessing the advertising application program interface, and the middleware component may dynamically generate the advertising control rules based on the client application identifier, the terminal context, and the user identifier. The triggering event may be defined in the terminal-resident advertising rules.

In another embodiment of the invention, a computer-readable storage medium has instructions executable by a processor of a terminal device for performing steps that include: a) downloading, via a network, particular advertising content to the terminal device; b) defining terminal-resident advertising control rules that are associated with the terminal device, wherein the advertising control rules are independent of the particular advertising content; c) determining a triggering event associated with a runtime operation of the terminal device; d) invoking the terminal-resident advertising control rules in response to the triggering event; and e) rendering the particular advertising content to the user via a terminal user application in accordance with the advertising control rules. The terminal device may include a middleware component having an advertising application program interface accessible via the terminal user application, and in such a case the terminal-resident advertising control rules may be defined via the application program interface.

In another embodiment of the invention, a system includes a terminal device and means for defining terminal-resident advertising control rules that are associated with the terminal device. The advertising control rules are independent of advertising content. The terminal device includes: a) means for downloading, via a network, particular advertising content to the terminal; b) means for determining a triggering event associated with a runtime operation of the terminal; c) means for invoking the terminal-resident advertising control rules in response to the triggering event; and d) means for rendering the particular advertising content to the user application in accordance with the advertising control rules.

In more particular embodiments, the terminal may further include means for dynamically generating the advertising control rules based on an attempt to access the rule by the terminal user application. In another case, the system may further include an ad service including means for providing at least one of the advertising control rules and the particular advertising content to the terminal device via a network. In such a case, the system may further include an advertiser computer arrangement that includes means for providing general advertising content and advertising goals to the ad service. Further, in such a case, the ad service may further include means for converting the general advertising content to the particular advertising content, and means for converting the advertising goals to the advertising control rules.

In another embodiment of the invention, an apparatus includes a network interface, memory, and a processor disposed between the memory and the network interface. The memory has instructions that cause the processor to define, for each of a plurality of user terminals, advertising control rules that are associated with the respective user terminal, wherein the advertising control rules are independent of advertising content. The instructions further cause the processor to provide the ad content to the plurality of user terminals via the network interface and provide, to each of the plurality of user terminals, the advertising control rules associated with the respective user terminal. The advertising control rules are configured to be invoked by the plurality of user terminals to render the particular advertising content by applications of the user terminals in response to a triggering event a associated with a runtime operation of each of the respective terminals.

In more particular embodiments, the instructions further cause the processor to receive general advertising content and advertising goals from an advertiser computer arrangement; convert the general advertising content to the particular advertising content; and convert the advertising goals to the advertising control rules.

These and various other advantages and features of novelty are pointed out with particularity in the claims annexed hereto and form a part hereof. However, for a better understanding of the invention, its advantages, and the objects obtained by its use, reference should be made to the drawings which form a further part hereof, and to accompanying descriptive matter, in which there are illustrated and described representative examples of systems, apparatuses, and methods in accordance with the invention.

### BRIEF DESCRIPTION OF THE DRAWING

The invention is described in connection with the embodiments illustrated in the following diagrams.

FIG. 1 is a block diagram illustrating a system according to embodiments of the invention;

FIG. 2 is a flowchart diagram illustrating a terminal architecture according to an embodiment of the invention;

FIGS. 3A and 3B are diagrams illustrating tailoring of ads in a user interface according to embodiments of the invention;

FIG. 4 is a sequence diagram illustrating system operating according to an embodiment of the invention;

FIG. 5 is block diagram of a mobile computing arrangement according to an embodiment of the invention;

FIG. 6 is block diagram of a service arrangement according to an embodiment of the invention; and

FIG. 7 is a flowchart showing a procedure according to an embodiment of the invention.

### DETAILED DESCRIPTION OF EMBODIMENTS OF THE INVENTION

In the following description of various exemplary embodiments, reference is made to the accompanying drawings that form a part hereof, and in which is shown by way of illustration various embodiments in which the invention may be practiced. It is to be understood that other embodiments may be utilized, as structural and operational changes may be made without departing from the scope of the present invention.

Generally, the present disclosure is directed to separating the control information pertaining to the advertisement and advertisement content itself so they can be created, delivered, stored and processed individually from each other. Such separation enables more flexible, more personable and more tightly device-bound advertisement. Only at the point of time when the control information (hereinafter referred to as “ad rules”) needs to be applied on advertisement content (hereinafter referred to as “ad content”), are both the ad rule and ad content are needed. The ad rules and ad content are typically combined when the ads are presented to users, and the combination typically takes place at the user's device. Until such time as the ad rules and ad content are combined, the ad rules and content can remain separate and independent. This facilitates a more efficient and more customizable experience than if the ad rules and ad content were inter-dependent.

One target technology for such advertising arrangements includes personalized advertisements at internet-capable devices. Therefore, the present invention is described in this context. The features described hereinbelow enable more flexible, more personalized and more tightly terminal-bound advertisements. The advertisements can be more specifically targeted based on user identity, type of application displaying the advertisement, type of terminal, terminal context, and other relevant factors surrounding the user and the user's environment.

The embodiments described herein may be applied to any devices using wireless or wired bearer. Possible bearers include, but are not limited to, 2G, 3G, Digital Video Broadcasting (DVB) (e.g., DVB-T/H/S/C), Terrestrial Integrated Services Digital Broadcasting (ISDB-T), Terrestrial Digital Multimedia Broadcasting (T-DMB), Digital Audio Broadcasting with Internet Protocol applications (DAB-IP), WiFi, WiMAX, Bluetooth, etc. Systems and methods may even be applied locally within a device context. For example, the embodiments may be applicable to software running on a device that does not connect to a network.

Various embodiments of the invention may be implemented as part of what is known as an AD-API. The AD-API is an Application Programming Interface (API) used by application developers that enables easier and more consistent placement of advertising on terminal applications. The AD-API is an interface that a terminal application can invoke to access the services in a local system component known as the Ad Client. The Ad Client may in turn retrieve an ad rule and ad content (or a pointer to ad content) that matches the request. The Ad Client also can execute parts or the entire ad rule if access to terminal platform is needed, or if the invoking application does not want to invoke the ad rule. The latter may be the case where the terminal application is satisfied with default behavior of the Ad Client, where the terminal application wants to maintain maximum backwards and forward compatibility, etc.

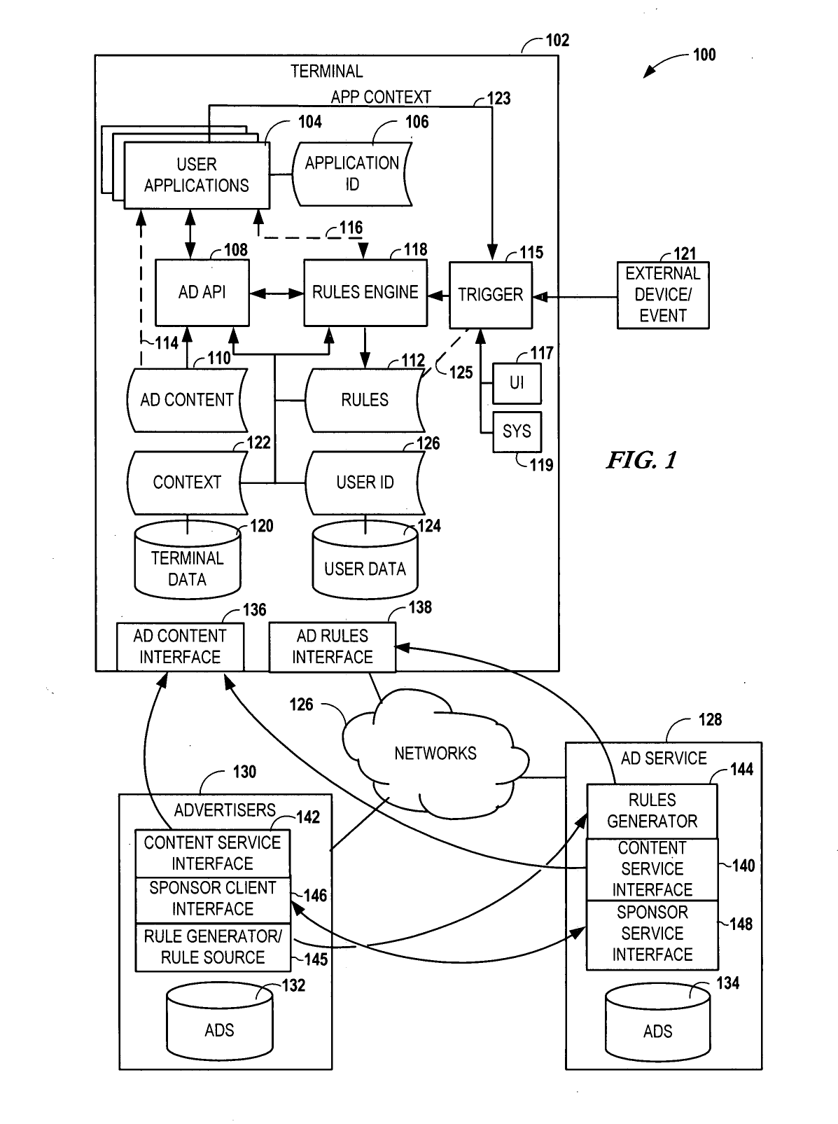

In reference now to FIG. 1, a system 100 according to an embodiment of the invention is illustrated. The system involves at least one terminal 102 that runs one or more terminal applications 104. Each application 104 may have an application ID 106, which may indicate any combination of application type/class, application name (e.g., application name presented to user, executable image name), application instance (e.g., where two or more instances of the same application may run at one time), application-specific context, and any other identifier/data that is relevant to display ads via the applications 104.

Generally, the applications are capable of rendering ad content to a user of the terminal 102, and the rendering may be controlled via AD API 108. The AD API 108 provides a uniform interface for the applications 104 to retrieve and manage ad materials directed to the end user. The AD API 108 at least provides access to independent ad content 110 and ad rule 112 data. The data 110, 112 may include both the content/rules themselves and references to the content/rules. For example, where an ad includes streaming video, it may be preferable for the ad content data 110 to include a reference (e.g., network identifier) to the video rather than storing the video locally. Also, ad rules may be generated instantaneously, upon request. For example, generic ad rule may indicate terminal to communicate the context to web server which would generate more detailed ad rule as response.

Although the AD-API 108 represents a preferred entry point for accessing content and rule data 110, 112, such data may also be accessed directly by the applications 104, as represented by path 114. Other advertising functionality may also be accessed without using the AD API 108, as represented by path 116 used to access a rules engine 118. Generally, the rules engine 118 is a functional component that may be used to dynamically generate the ad rules 112, and may also be used to execute those rules 112. In the illustrated embodiment, the applications 104 may access the ad rules via one or both of the AD API 108 and the rule engine 118, although the applications 104 may also be configured to directly access the ad rule data 112.

The rules engine 118 may take into account various pieces of relevant data when generating and/or executing rules 112. One example already discussed is the application ID 106. Other relevant data may include terminal device data 120, and in particular terminal context 122. The context 122 may describe any state or condition of the terminal 102 that may be subject to periodic change, including location, time of day, network bearers, software versions, currently attached peripheral devices, etc. Data 124 related to the user, as represented by user ID 126, may also be relevant in the generating and/or execution of rules 112 by the rules engine 118.

Another example of relevant data than may be taken into account by the rules engine 118 is represented by trigger 115. Generally, the trigger 115 may be any happening or event that causes an ad rule 112 to be invoked and/or causes and ad to be accessed 114, 116. As discussed above, terminal context 122 may be used to generate/execute rules, and such context 122 may be determined indirectly or directly from terminal hardware, as represented by user interface 117 and system 119 event originators, and external device/event 121. The applications 104 may also generate triggers 115, as represented by application context event 123. The triggers 115 may be predefined in the rules engine 118 and/or defined in the rules 112 themselves, as indicated by line 125.

The applications 104, AD API 108, and rules engine 118 may be designed to interact entirely within the terminal, such that the rules 112 are locally generated and the ad content 110 is all stored on the terminal 102. However, the terminal device 102 is typically capable of connecting to one or more networks 126, and therefore these functional components 104, 108, 118 may be able to utilize network services, such as represented by ad service 128 and advertisers 130. Generally, the ad service 128 may be a single point of entry for multiple advertisers 130 to distribute ads to a plurality of terminals. The advertisers 130 originate (possibly unprocessed) ad content 132 and pay to have it distributed by the service 128. The service 128 may manage its own processed or unprocessed ad content 134, and provide a consistent way to distribute that content to devices such as terminal 102.

The terminal 102 may include an ad content network interface 136 for receiving content for the ad service 128 via content service interface 140 and/or directly from advertisers 130 via content service interface 142. Similarly, the terminal 102 may include an ad rules interface 138 for downloaded some or all of the rule data 112 that is then stored on the terminal 102. The ad rules interface 138 typically interfaces with the centralized service entity 128, although it is possible that the rules interface could interface directly with advertisers 130. The ad service 128 includes a rule generation module 144 that may provide some or all of the locally used rules data 112 via the terminal's rules interface 138. The rule generation module 144 may generate rules locally, or receive them from a rule generator/rule source 145 of the advertisers 130.

The ad service 128 may be a convenient point to manage interactions between numerous terminal applications 104 and numerous advertisers 130. The ad service 128 can assist the terminal applications 104 in preparing highly tailored specific presentations of ads through the use of the independent content 110 and rules 112. These presentations may be prepared from general ad content 132 provided from the advertisers 130, and other generally specified goals (e.g., target demographics, number of users targeted, target devices, target applications) communicated between the advertisers 130 and the service 128. The communication of content and goals between the advertisers 130 and service 128 is represented by respective sponsor interfaces 146, 148. In response, the ad service 128 can tailor rules 112 and content 110 directed to the particular terminal 102 to suit the goals of the advertisers 130 as well as providing a personalized experience to the user of the terminal 102.

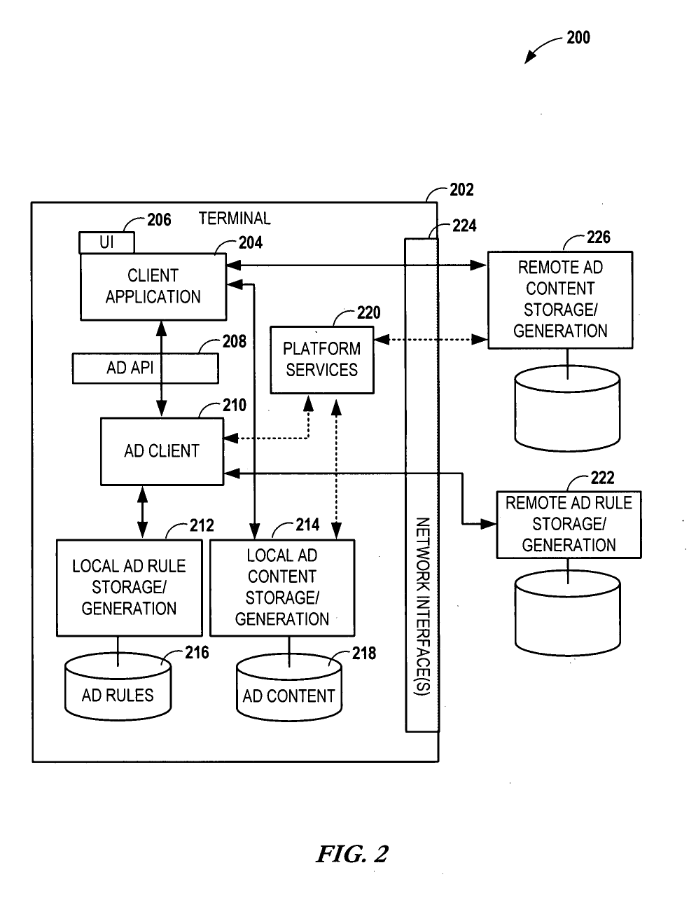

In reference now to FIG. 2, a block diagram presents a more detailed view of a terminal architecture 200 according to an embodiment of the invention. A terminal arrangement 202 includes a client application 204 that may include any user program or service known in the art. Generally, the client application 204 will have a user interface 206 capable of rendering ads to a user. The ads may be rendered in any format, including text, graphic, video, sounds, etc. The client application 204 manages the ads via a local ad API 208 which facilitates communications with an ad client 210.

Generally, the ad client 210 is a locally running process that manages ad rules and ad content for clients of the terminal 202, as represented by local ad rule storage/generation 212 and local ad content storage/generation 214. As these names indicate, these components 212, 214 may handle persistent storage of respective rule and content data (e.g., via data storage media 216, 218) and/or may dynamically generate rule and content data. The term “ad rules” as used herein and generally indicated by way of reference numeral 216 may refer to both statically stored and dynamically generated rules.

The ad rules 216 may include one or more rules that describe how to apply ad content 218 (or a pointer/reference to ad content) in a particular way. The ad rules 216 may be realized with XML or some other structural language. The ad rules 216 may include executable code in the form of binary instructions, interpreted script language, interpreted object code (e.g., Java objects), and other executable instructions known in the art. The ad rules may be interpreted/executed either independently or jointly by the client application 204, ad client 210 or terminal platform 220 (e.g., terminal utilities, terminal operating system, firmware, etc). The ad rules 216 may be generated and stored locally on the terminal 202, or be obtained from a remote ad rule service 222 via way of a network interface 224.

Generally, “ad rules,” as the term is used herein, may be considered independent from presentation rules. For example, cascading style sheets (CSS) are a technology that allows a browser engine to define/modify the presentation of content (e.g., format of textual data) separate from the content itself. However, technologies such as CSS are only concerned with aspects related to visual rendering of Web content in a browser. Although ad rules may also have the ability to define some aspects pertaining to presentation, the ad rules may be more intimately bound to terminal resources, and need not be tied to browser-specific presentation methods. For example, unlike CSS, an “ad rule” does not require (and preferably does not rely solely on) a browser engine to operate, as it can directly affect non-browser terminal capabilities such as menus, system settings, background graphic, system sounds, etc. Further, the ad rules themselves may be separated from particulars of presentation. For example, other generalized rules, such as system settings, may affect the ad rule's display of the ad content, thus possibly overriding presentation rules (if any) that may be included with the ad rules.]

As previously described, ad rules 216 can be created at the time the ad client 210 accesses the rule. For example, when the ad client 210 requests <ad_rule> that matches with <client_app_id>, <context>, <user_id>, the serving node (local/remote ad rule storage/generation 212, 222) can either provide a ready-to-serve/stored <ad_rule> or generate the <ad_rule> on the spot. Further, when the <ad_rule> is generated on the spot, the generating entity 212, 222 uses the previous context information, current context information, user id and application id to provide as relevant and personalized <ad_rule> as possible. The dynamically generated <ad_rule> can be stored for later reuse, and be indexed by any combination of <client_app_id>, <context>, <user_id> for easy retrieval. In cases where storage is at a premium over processing bandwidth, the <ad_rule> can be discarded after use, and regenerated later if needed.

The <ad_rule> obtained from one or both of the (local/remote ad rule storage/generation components 212, 222) is applied to one or more instances of <ad_content> retrieved from the local ad content storage/generation component 214, or from an analogous remote component 226 accessible via the network interface 224. The <ad_content> can be any combination of audio file, video file, audio stream, video stream, picture, slideshow, executable/interpretable code, hypertext document, scene description or any other user perceivable digital media known in the art.

The <ad_content> can be created at the time the ad client 210 and/or client application/terminal platform accesses the <ad_content>. In other words, when the <ad_content> is requested, the serving node (local and/or remote ad content storage/generation 214, 224) can either provide ready-to-serve/stored <ad_content> or generate the <ad_content> on the spot. Further, when the <ad_content> is generated on the spot, the generating entity 214, 224 uses the previous context information, current context information, user id, application id and <ad_rule> to provide as relevant, personalized and tailored-to-application <ad_content> as possible.

The ad rules as described herein may describe any aspect of rendering user perceivable materials, including graphic location/placement, size, color, temporal aspects, pre/post-processing, association with metadata, signal processing, etc. If expressed in English, an ad rule could state, for example: “render the ad_content as a new banner on the top of current screen;” “to terminal ‘Options’ menu, add new entry ‘Buzz-Cola Online,’ and associate ad_content as icon on that entry and link the entry to www.buzz-cola.com;” “in the currently running video-on-demand content, at 3 min after start, insert the ad_content as video clip within the stream.”

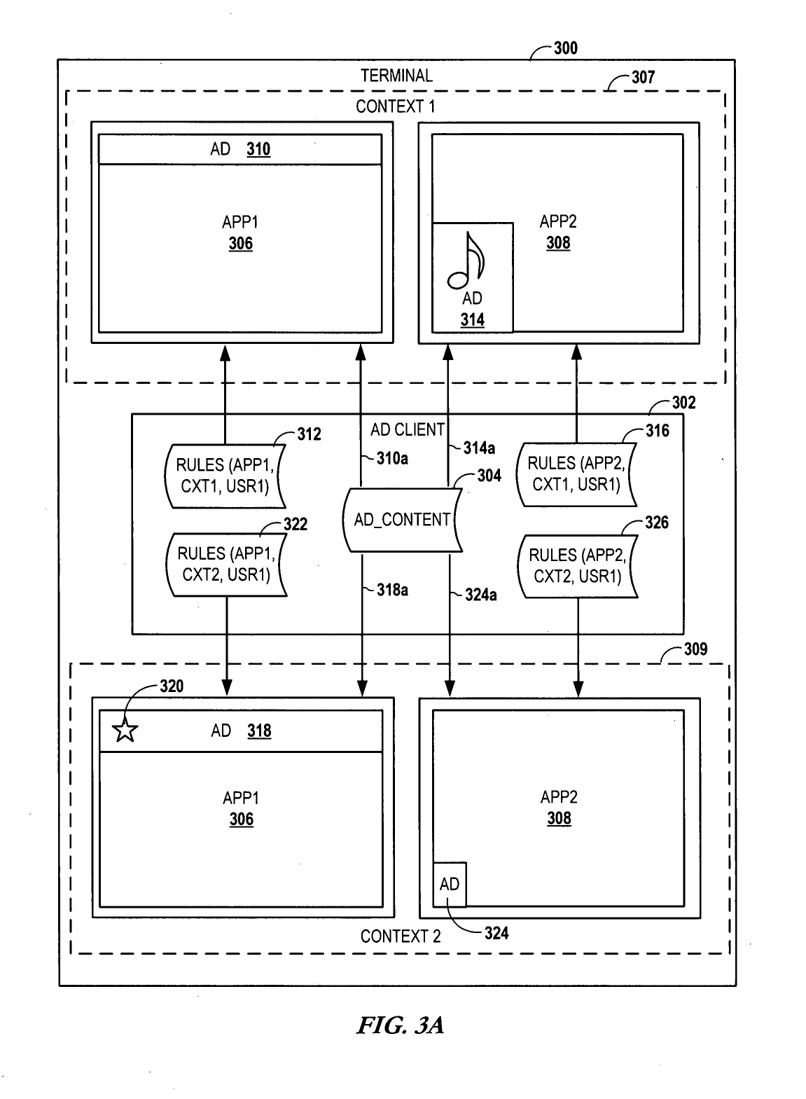

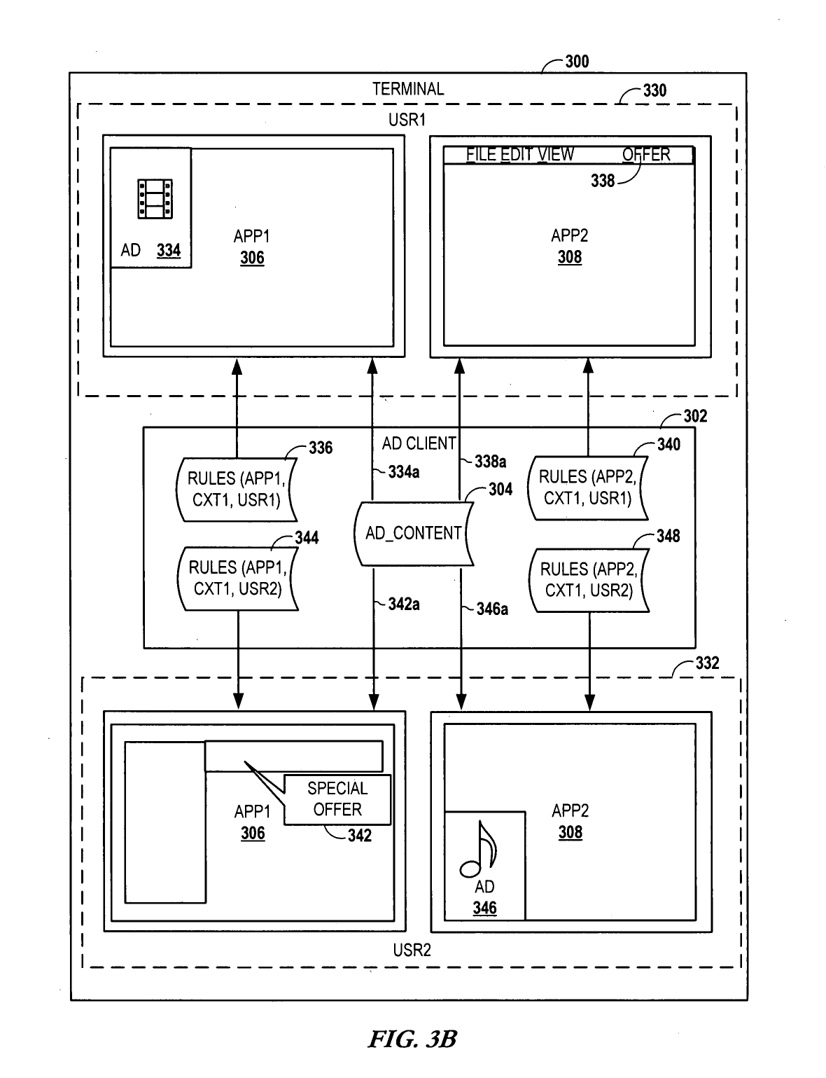

An example of how ad content may be tailored based on ad rules according to an embodiment of the invention is shown in the block diagram of FIG. 3A. In this scenario, a terminal 300 includes an ad client 302 (or similar system component) that processes a single item of ad content 304 differently based on various known parameters. The ad content 304 may include any combination of statically stored and dynamically generated data, and is capable of being rendered to the terminal user (identified as “USR1” in this example) by at least applications 306 and 308 (identified as “APP1” and “APP2,” respectively). Further, the terminal 300 is capable of detecting differing contexts of the terminal 300, represented here as context 307 and 309. The contexts 307, 309 may be defined by any combination of location, time, environmental conditions, terminal state, connectivity state, etc.

The ad client 302 makes a determination of current context, user identity, and requesting application to provide rules for rendering the ad content 304. For example, in context 307, application 306 receives content 310a (which may be all of content 304 or a subset thereof) and renders content 310 as a banner 310, as dictated by rules 312. In the same context 307, the application 308 receives content 314a (which may be all of content 304 or a subset thereof) from content 304, and renders the ad content 314a as a window 314 that includes sound, as dictated by rules 316. In a different context 309, application 306 receives content 318a (which may be all of content 304 or a subset thereof) from content 304, and renders the ad content 318a in accordance with rules 322 as a banner 318, although slightly larger than banner 310 in context 307, and with an additional interactive feature 320 (e.g., a selectable graphic that allows the user to take advantage of a special offer). Also in context 309, application 308 has received content 324a (which may be all of content 304 or a subset thereof) from content 304, and minimized the display of the ad content 324a to a small icon 324 as dictated by rules 326.

In FIG. 3B, another example shows how ad content may be tailored based on ad rules according to an embodiment of the invention. In FIG. 3B, the same reference numbers may be used to denote similar components as described in relation to FIG. 3A. In particular, terminal 300 includes ad client 302 that processes ad content 304 differently based on various known parameters. In this example, the different parameters includes different user accounts, user account 330 and user account 332.

The ad client 302 makes a determination of current context (here a constant), user identity, and requesting application to provide rules for rendering the ad content 304. For user 330, application 306 receives content 334a (which may be all of content 304 or a subset thereof) and renders content 334a as a video 334, as dictated by rules 336. For the same user 330, the application 308 receives content 338a (which may be all of content 304 or a subset thereof) from content 304, and renders the ad content 338a as a menu option 338 as dictated by rules 340. For the other user 332, application 306 receives content 342a (which may be all of content 304 or a subset thereof) from content 304, and renders the ad content 342a in accordance with rules 344 as a rollover popup window 342. Also for user 332 application 308 has received content 346a (which may be all of content 304 or a subset thereof) from content 304, and rendered the content 346a as a sound 346 as dictated by rules 348.

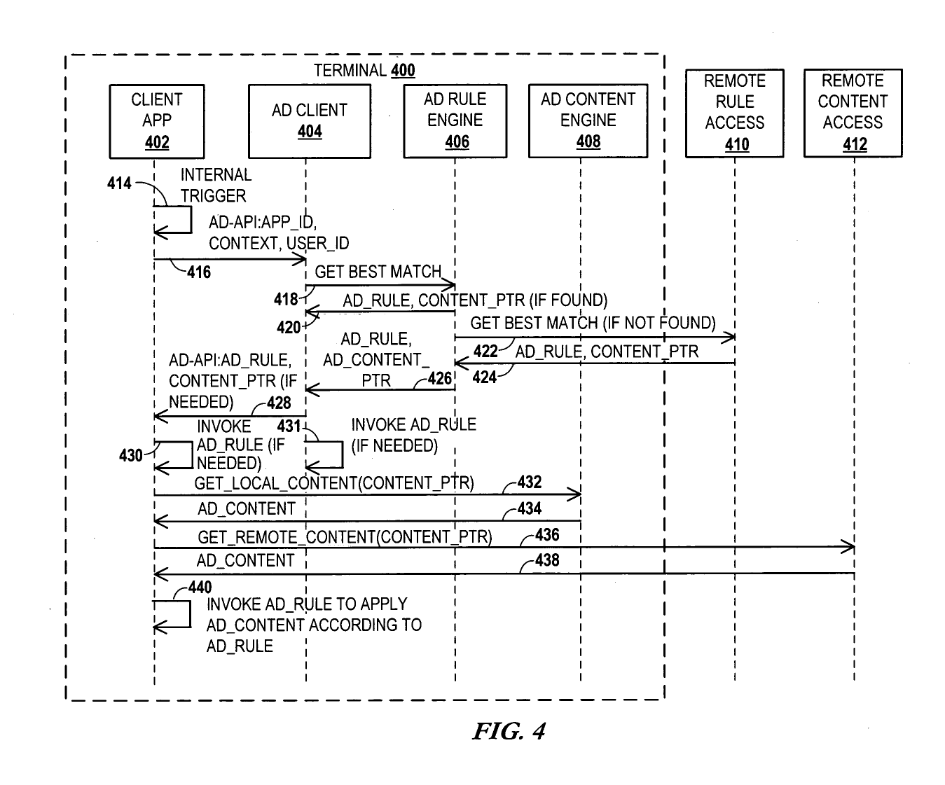

In reference now to FIG. 4, a sequence diagram illustrates component interactions in a device and system according to embodiments of the invention. The scenario in FIG. 4 involves a terminal 400 having a client application 402 capable of rendering ads to a user. The client application 402 communicates with an ad client 404 of the terminal 400 such as via an AD API (not shown). Generally, the ad client 404 exposes the API and the client application 402 invokes the API, although other arrangements are also possible. The terminal 400 also contains local ad rule engine 406 and ad content engine 408 that locally and independently provide respective ad rules and ad content for the ad client 404 and client application 402. In some implementations, externally accessible ad rule access component 410 and ad content access component 412 can provide respective ad rules and ad content to the terminal 400.

The illustrated sequence in FIG. 4 begins when the client application 402 detects an internal trigger 414 for showing and application. This trigger 414 may include application startup, internal method/procedure, user input, operating system event, time, sensor condition, etc. In response to the triggering event 414, the client application 402 invokes 416 the AD API using the app-id associated with the application 402, a terminal context, and a user-id. In response to the API invocation 416, the ad client 404 queries 418 the ad rule engine 406 for the best match. The ad rule engine 406 may configured as a data store, in which case the query 418 may be similar to a traversal through a data file or filesystem. In other configurations, the ad rule engine 406 may include its own efficient data searching routines, in which case the query 418 may include a high-level abstraction of the desired results (e.g., similar to a Structure Query Language query).

If the ad rule engine 406 can satisfy the query 418, a result 420 is returned that may include an ad rule and a reference/pointer to relevant content. If the ad rule engine 406 cannot satisfy the query 418, then it may be forwarded 422 to the remote rule access 410, which may be able to satisfy the forwarded query 422 as represented by returned rule and ad pointer 424, 426. If the initial API call 416 was satisfied remotely or locally, the resulting rule and ad content pointer is returned 428 to the client application 402 via the API. The ad rule 428 may require that either or both of the client application 402 and ad client 404 invoke 430, 431 some part of the ad rule to complete this phase of processing. These invocations 430, 431 may involve processing part of the rules via the locally running components 402, 404, and/or may involve invoking services of the underlying terminal platform 400.

The API is shown returning 428 a reference to the ad content, although the return call 428 may also include the content itself. If a reference to the content is returned, then the client application may get local content 432, 434 from the ad content engine 408 and/or get remote content 436, 438 from remote content access 412. These accesses 432, 434, 436, 438 are shown being obtained directly via the client application 402, but in some implementations may also occur by way of an intermediary, such as via the ad client 404 and AD API. With both rules and content in place, the client application 402 can finalize the invocation 440 of the ad rule to apply the content according to the rules.

It will be appreciated that the sequence of events in FIG. 4 is merely exemplary, and many variations are possible in light of the description herein. For example, sequence of retrieving rules and content initiated by API call 416 may be automatically performed at startup of the terminal 400 and/or application 402. In such a case, the internal trigger 414 may be defined as part of the rules 428 returned to the application 402. Thereafter, the invocation of rules 430, 432, the retrieval of content 434, 438, and/or application 440 of the rule to the content may be performed in response to the trigger 414. In other variations, it is noted that the ad content and ad rules may be independent from each other, and so the retrieval of rules 428 can be performed independently of retrieval of content 434, 438. For example, retrieval of content 434, 438 could be a continuous, low-bandwidth operation and application 440 of rules to apply the content may be delayed until such time as sufficient or relevant content is accessible.

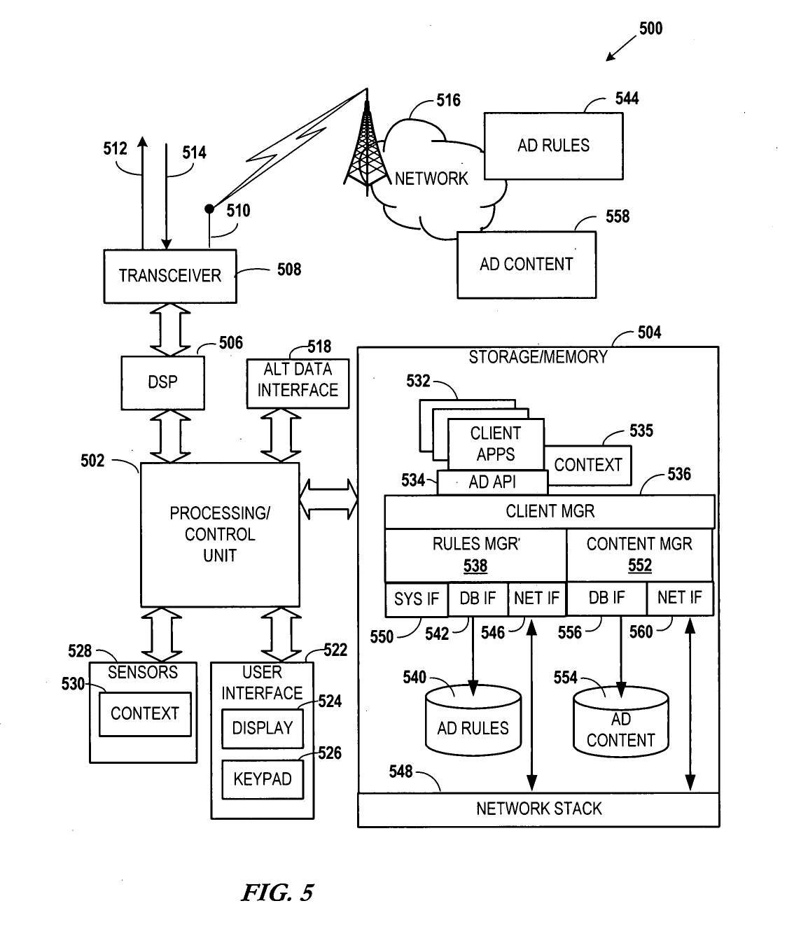

Many types of apparatuses may be able participate in viewing customized/personalized ad materials as described herein. Mobile devices are particularly useful in this role. In reference now to FIG. 5, an example is illustrated of a representative mobile computing arrangement 500 capable of carrying out operations in accordance with embodiments of the invention. Those skilled in the art will appreciate that the exemplary mobile computing arrangement 500 is merely representative of general functions that may be associated with such mobile devices, and also that landline computing systems similarly include computing circuitry to perform such operations.

The processing unit 502 controls the basic functions of the arrangement 500. Those functions associated may be included as instructions stored in a program storage/memory 504. In one embodiment of the invention, the program modules associated with the storage/memory 504 are stored in non-volatile electrically-erasable, programmable read-only memory (EEPROM), flash read-only memory (ROM), hard-drive, etc. so that the information is not lost upon power down of the mobile terminal. The relevant software for carrying out conventional mobile terminal operations and operations in accordance with the present invention may also be transmitted to the mobile computing arrangement 500 via data signals, such as being downloaded electronically via one or more networks, such as the Internet and an intermediate wireless network(s).

The mobile computing arrangement 500 includes hardware and software components coupled to the processing/control unit 502 for performing network data exchanges. The mobile computing arrangement 500 may include multiple network interfaces for maintaining any combination of wired or wireless data connections. In particular, the illustrated mobile computing arrangement 500 includes wireless data transmission circuitry for performing network data exchanges.

This wireless circuitry includes a digital signal processor (DSP) 506 employed to perform a variety of functions, including analog-to-digital (A/D) conversion, digital-to-analog (D/A) conversion, speech coding/decoding, encryption/decryption, error detection and correction, bit stream translation, filtering, etc. A transceiver 508, generally coupled to an antenna 510, transmits the outgoing radio signals 512 and receives the incoming radio signals 514 associated with the wireless device.

The incoming and outgoing radio signals 512, 514 are used to communicate with a mobile service provider network 516. The network 516 may include any voice and data communications infrastructure known in the art, including CDMA, W-CDMA, GSM, EDGE, etc. The network 516 typically provides access to traditional landline data infrastructures, including IP networks such as the Internet. The mobile computing arrangement 500 may also include an alternate network/data interface 518 capable of accessing the network 516 and/or a proximity network (not shown). The alternate data interface 518 may incorporate combinations of I/O and network standards such as USB, Bluetooth, Ethernet, 802.11 Wi-Fi, IRDA, etc. The alternate data interface 518 may be receive-only, and capable of receiving broadcast/unicast digital or analog encoded video, audio, text, and other user perceivable data via wired or wireless media.

The processor 502 is also coupled to user-interface elements 522 associated with the mobile terminal. The user-interface 522 of the mobile terminal may include, for example, a display 524 such as a liquid crystal display. Other user-interface mechanisms may be included in the interface 522, such as keypads 526, speakers, microphones, voice commands, switches, touch pad/screen, graphical user interface using a pointing device, trackball, joystick, etc. One or more sensors 528 may also be coupled to the processor 502. The sensors 528 may include sensor(s) 530 capable of determining terminal context, including any combination of time, location, acceleration, proximity, environmental conditions, electromagnetic/optical transmissions, etc. These and other external interface components are coupled to the processor 502 as is known in the art.

The program storage/memory 504 typically includes operating systems and programs for carrying out functions and applications associated with functions on the mobile computing arrangement 500. The program storage 504 may include one or more of read-only memory (ROM), flash ROM, programmable and/or erasable ROM, random access memory (RAM), subscriber interface module (SIM), wireless interface module (WIM), smart card, hard drive, or other removable memory device. The storage/memory 504 of the mobile computing arrangement 500 may also include software modules for performing functions according to embodiments of the present invention.

In particular, the program storage/memory 504 may include one or more client applications 532 that facilitate render advertising materials to a user of the arrangement 500. The client application 532 can access an ad API 534 that provides a common interface for multiple applications 532 to retrieve, manage, and render advertising materials in a customizable manner. A client manager 536 manages states and data of the client applications 532 that are communicated to the manager 536 via the API 534. The client applications 532, API 534 and/or client manager 536 may be able to determine a local context 534 associated with and combination of context sensor 530, the applications 532, or any other software, operating system, user identity, system utility, running on the arrangement 500. The client manager 538 uses a rules manager 538 for performing rule functions, which may include rule formation, identification, validation, query, storage, download, invocation, etc. The rules manager 538 may deal with locally stored rules 540 via a database interface 542, and may deal a remote network rule service 544 by way of a rules network interface 546 and a network stack 548 of the arrangement 500. The rules manager 538 may also access other relevant system data, including application identifiers, user identifiers, and terminal context, via a system interface 550.

The client manager 536 may also use a content manager 552 for performing content functions, which may include content formation, identification, validation, query, storage, download, etc. The content manager 552 may deal with locally stored content 554 via a database interface 556, and may deal a remote network rule service 558 by way of a rules network interface 560 and the network stack 548. Generally, the rules manager 538 and content manager 552 may operate independently, at least such that the rules manager 538 need not be aware of any specific content to perform rule management functions, and the content manager 552 need not be aware of any specific rules to perform content management functions.

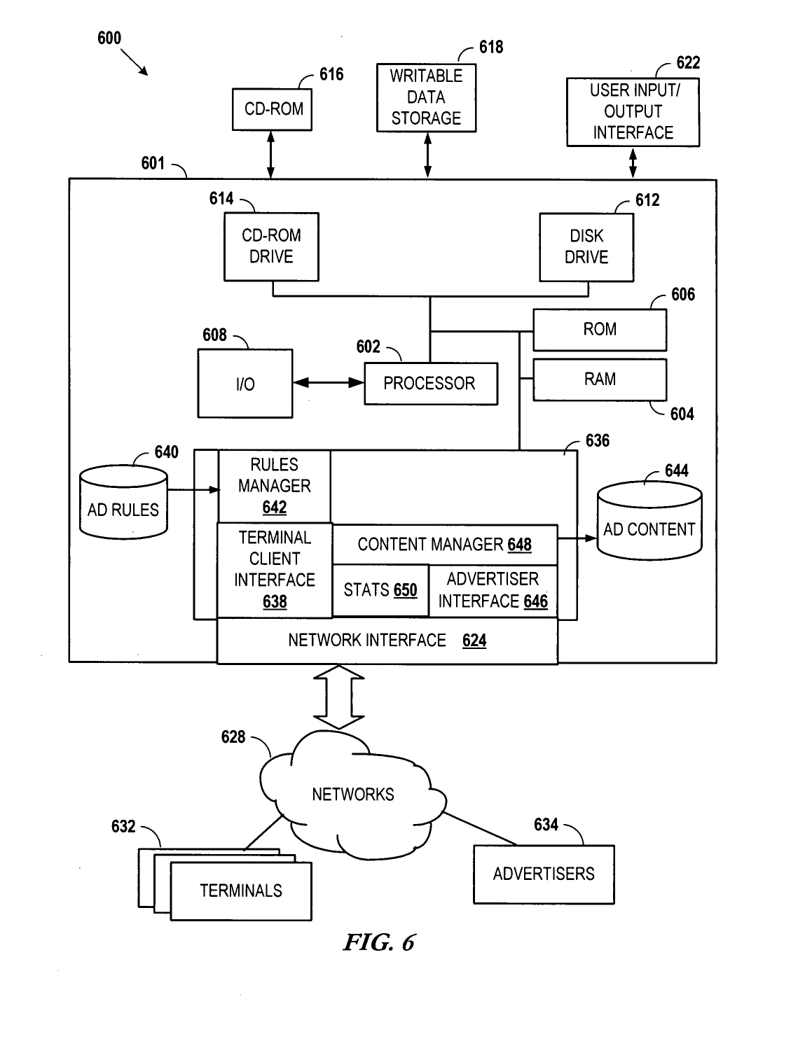

An ad distribution system as described herein can be implemented using one or more network servers to gather, coordinate, and distribute ad rules and ad content as described herein. In reference now to FIG. 6, a block diagram illustrates an example ad service arrangement 600 according to an embodiment of the invention. The service arrangement 600 includes a computing arrangement 601. The computing arrangement 601 may include custom or general-purpose electronic components. The computing arrangement 601 includes a central processor (CPU) 602 that may be coupled to random access memory (RAM) 604 and/or read-only memory (ROM) 606. The ROM 606 may include various types of storage media, such as programmable ROM (PROM), erasable PROM (EPROM), etc. The processor 602 may communicate with other internal and external components through input/output (I/O) circuitry 608. The processor 602 carries out a variety of functions as is known in the art, as dictated by software and/or firmware instructions.

The computing arrangement 601 may include one or more data storage devices, including disk drives 612, CD-ROM drives 614, and other hardware capable of reading and/or storing information such as DVD, etc. In one embodiment, software for carrying out the operations in accordance with the present invention may be stored and distributed on a CD-ROM 616, writable data storage media 618 or other form of media capable of portably storing information, including magnetic media, flash memory, etc. These storage media may be inserted into, and read by, devices such as the CD-ROM drive 614, the disk drive 612, I/O ports 608, etc. The software may also be transmitted to computing arrangement 601 via data signals, such as being downloaded electronically via a network, such as the Internet 628. The computing arrangement 601 may be coupled to a user input/output interface 622 for user interaction. The user input/output interface 622 may include apparatus such as a mouse, keyboard, microphone, touch pad, touch screen, voice-recognition system, monitor, LED display, LCD display, etc.

The computing arrangement 601 may be coupled to other computing devices via networks. In particular, the computing arrangement includes a network interface 624 for communicating with networks 628. The network interface 624 may include a combination of hardware and software components, including media access circuitry, drivers, programs, and protocol modules. The networks 628 may include any combination of private or public networks such as the Internet. The networks 628 allow the computing arrangement 601 to communicate with entities such as participating terminal devices 632, and advertiser devices 634 (e.g., devices of those entities who supply and pay for sponsored ads).

The computing arrangement 601 includes processor executable instructions 636 for carrying out management tasks of the computing arrangement 601. These instructions 636 may include a client terminal interface 638 capable of servicing requests for ad rules and ad content from terminal devices 632. Ad rules may be stored on a local database 640 and accessed via a rules manager 642. The rules manager 642 may handle rule operations such as rule formation, identification, validation, query, storage, download, etc. The rules manager 642 may work in concert with goals provided by advertisers 634 (e.g., target demographics, preferred media and placement) although the rules 640 are generally independent from ad content 644 which may be provided by the advertisers 634.

The advertisers 634 may communicate with the arrangement 601 via an advertiser interface 646. The advertiser interface 646 may allow for submission of ad content to be stored in content database 644 as well as other relevant data describe desired outcomes of the advertisements. A content manager 648 generally manages interactions related to ad content 644 generation and storage, and may provide other ad content functionality such as identification, validation, query, download, etc. The advertisers 634 may also desire to get feedback via the advertiser interface 646 regarding advertisements managed by the service arrangement 600. For example, the terminal client interface 638 may be able to gather usage statistics from the terminals 632, and these can be conditioned by a statistics module 650 and reported back to advertisers 632 via the advertiser interface 646.

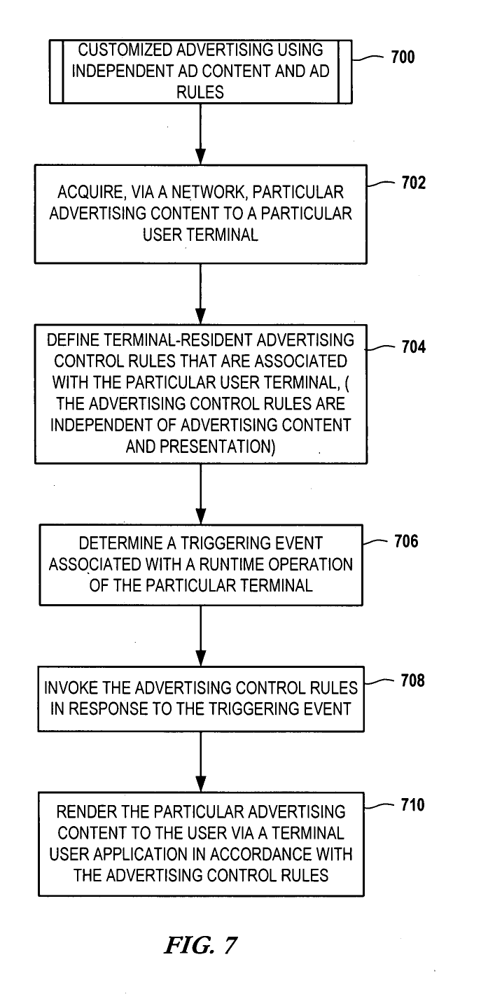

In reference now to FIG. 7, a flowchart illustrates a procedure 700 for customized advertising using independent ad content and ad rules. Particular advertising content is acquired 702 to a particular user terminal. This acquisition 702 may include any manner of data download, synchronization, or update that occurs in response to other events of the procedure, or be an independent download/installation/synchronization event. Terminal-resident advertising control rules that are associated with the particular user terminal are defined 704. The advertising control rules are independent of the particular advertising content, and the rules may be defined 704 by the device or elsewhere (e.g., via a network service). A triggering event associated with a runtime operation of the particular terminal is determined 706. The advertising control rules are invoked 708 in response to the triggering event. The particular advertising content is rendered 710 to the user via a terminal user application in accordance with the advertising control rules.

The foregoing description of the exemplary embodiments of the invention has been presented for the purposes of illustration and description. It is not intended to be exhaustive or to limit the invention to the precise form disclosed. Many modifications and variations are possible in light of the above teaching. It is intended that the scope of the invention be limited not with this detailed description, but rather determined by the claims appended hereto.

What is claimed is:

1. A method comprising:
acquiring, via a network, particular advertising content to a particular user terminal;
defining terminal-resident advertising control rules that are associated with the particular user terminal, wherein the advertising control rules are independent of the particular advertising content;
determining a triggering event associated with a runtime operation of the particular terminal;
invoking the advertising control rules in response to the triggering event; and
rendering the particular advertising content to the user via a terminal user application in accordance with the advertising control rules.

2. The method of claim 1, further comprising dynamically generating the advertising control rules based on an attempt to access the rule by the terminal user application.

3. The method of claim 1, wherein defining the terminal-resident advertising control rules comprises defining the advertising rules via a middleware component having an advertising application program interface accessible via the terminal user application.

4. The method of claim 3, wherein the triggering event comprises an access of the advertising application program interface via the terminal user application.

5. The method of claim 4, wherein invoking the terminal-resident advertising control rules comprises invoking at least part of the terminal-resident advertising control rules by the middleware component.

6. The method of claim 3, wherein defining the terminal-resident advertising control rules comprises dynamically generating the advertising control rules via the middleware component based on an access of the advertising application program interface via the terminal user application.

7. The method of claim 6, wherein the access of the advertising application program interface comprises providing a client application identifier, a terminal context, and a user identifier from the terminal user application to the middleware component.

8. The method of claim 7, wherein the middleware component dynamically generates the advertising control rules based on the client application identifier, the terminal context, and the user identifier.

9. The method of claim 1, wherein acquiring the particular advertising content to the particular user terminal comprises downloading the particular advertising content independently of the triggering event.

10. The method of claim 1, further comprising defining the triggering event in the terminal-resident advertising rules.

11. A terminal device comprising:
a network interface;
memory; and
a processor disposed between the memory and the network interface, wherein the memory stores a user application and has instructions that causes the processor to:
acquire, via the network interface, particular advertising content to the terminal device;
define terminal-resident advertising control rules that are associated with the terminal device, wherein the advertising control rules are independent of advertising content;
determine a triggering event associated with a runtime operation of the terminal device;
invoke the terminal-resident advertising control rules in response to the triggering event; and
render the particular advertising content to the user application in accordance with the advertising control rules.

12. The terminal device of claim 11, further comprising a middleware component stored in the memory, the middleware component having an advertising application program interface accessible via the user application, wherein the middleware component has instructions that at least cause the processor to define the advertising control rules that are associated with the terminal device.

13. The terminal device of claim 12, wherein the middleware has instructions that cause the processor to determine the triggering event based on an access of the advertising application program interface via the terminal user application.

14. The terminal device of claim 12, wherein the middleware component has instructions that cause the processor to define the terminal-resident advertising control rules by dynamically generating the advertising control rules based on an access of the advertising application program interface via the user application.

15. The terminal device of claim 14, wherein the user application provides a client application identifier, a terminal context, and a user identifier from the terminal user application to the middleware component when accessing the advertising application program interface.

16. The terminal device of claim 15, wherein the middleware component dynamically generates the advertising control rules based on the client application identifier, the terminal context, and the user identifier.

17. The terminal device of claim 11, wherein the triggering event is defined in the terminal-resident advertising rules.

18. A computer-readable storage medium having instructions executable by a processor of a terminal device for performing steps comprising:
downloading, via a network, particular advertising content to the terminal device;
defining terminal-resident advertising control rules that are associated with the terminal device, wherein the advertising control rules are independent of the particular advertising content;
determining a triggering event associated with a runtime operation of the terminal device;
invoking the terminal-resident advertising control rules in response to the triggering event; and
rendering the particular advertising content to the user via a terminal user application in accordance with the advertising control rules.

19. The computer-readable storage medium of claim 18, wherein the terminal device includes a middleware component having an advertising application program interface accessible via the terminal user application, and wherein the terminal-resident advertising control rules are defined via the application program interface.

20. A system comprising:
a terminal device; and
means for defining terminal-resident advertising control rules that are associated with the terminal device, wherein the advertising control rules are independent of advertising content;
wherein the terminal device comprises:
means for downloading, via a network, particular advertising content to the terminal;
means for determining a triggering event associated with a runtime operation of the terminal;
means for invoking the terminal-resident advertising control rules in response to the triggering event; and
means for rendering the particular advertising content to the user application in accordance with the advertising control rules.

21. The system of claim 20, wherein the terminal further comprises means for dynamically generating the advertising control rules based on an attempt to access the rule by the terminal user application.

22. The system of claim 20, further comprising an ad service including means for providing at least one of the advertising control rules and the particular advertising content to the terminal device via a network.

23. The system of claim 22, further comprising an advertiser computer arrangement including means for providing general advertising content and advertising goals to the ad service, wherein the ad service further comprises means for converting the general advertising content to the particular advertising content, and means for converting the advertising goals to the advertising control rules.

24. An apparatus comprising:
a network interface;
memory; and
a processor disposed between the memory and the network interface, wherein the memory has instructions that cause the processor to:
define, for each of a plurality of user terminals, advertising control rules that are associated with the respective user terminal, wherein the advertising control rules are independent of advertising content;
provide the ad content to the plurality of user terminals via the network interface;
provide, to each of the plurality of user terminals, the advertising control rules associated with the respective user terminal; and
wherein the advertising control rules are configured to be invoked by the plurality of user terminals to render the particular advertising content by applications of the user terminals in response to a triggering event a associated with a runtime operation of each of the respective terminals.

25. The apparatus of claim 24, wherein the instructions further cause the processor to:
receive general advertising content and advertising goals from an advertiser computer arrangement;
convert the general advertising content to the particular advertising content; and
convert the advertising goals to the advertising control rules.
